(19) United States
(12) Patent Application Publication
(10) Pub. No.: US 2025/0345712 A1
(43) Pub. Date: Nov. 13, 2025

(54) METHODS AND SYSTEMS FOR ENHANCED BOOKMARKING FOR VIDEO GAMES

(71) Applicant: Sony Interactive Entertainment Inc., Tokyo (JP)

(72) Inventors: Mahdi Azmandian, San Mateo, CA (US); Steven Osman, San Francisco, CA (US); Olga Rudi, San Francisco, CA (US); Jorge Arroyo Palacios, Livermore, CA (US)

(21) Appl. No.: 18/657,727

(22) Filed: May 7, 2024

(51) Int. Cl. A63F 13/85; A63F 13/213; A63F 13/40

(52) U.S. Cl. CPC A63F 13/85; A63F 13/213; A63F 13/40; A63F 2300/1081

(57) ABSTRACT

Methods and systems are provided for recording gameplay moments during gameplay of a video game is provided. The method includes executing the video game to generate a plurality of video frames. The method includes receiving inputs from a player of the video game. The inputs facilitate said gameplay of the video game by the player and causes updating of said plurality of video frames as the player makes progress in the video game. The method includes receiving an input to bookmark a frame region rendered in a video frame of said plurality of video frames. The method includes associating an identifier to the bookmark. The identifier is descriptive of content present in the frame region. The method includes saving state data for the bookmark. The state data for the bookmark enables subsequent selection of the bookmark from a user interface to load at least the video frame along with said identifier.

### BACKGROUND

### 1. Field of the Disclosure

The present disclosure relates generally to computer implemented methods used for assisting players to identify and bookmark memorable moments during gameplay.

### 2. Description of the Related Art

The video game industry has seen many changes over the years. Users are now able to play video games using many types of peripherals and computing devices. Sometimes video games are played using a game console, where the game console is responsible for processing the game and generating the interactive input presented on display screens. Other times, video games are played in streaming mode, where a server or servers execute the game remotely and users provide input over a network connected device.

Although video game technology has seen many advances, games and game worlds have become very complex. The complexity sometimes confuses players or prevents players from recalling memorable moments. Further, it is often hard to go back to earlier game play to find interesting events or content that occurred.

It is in this context that implementations of the disclosure arise.

### SUMMARY

Implementations of the present disclosure include methods, systems, and devices for enabling bookmarking of content and generating of bookmark content using contextual analysis, state data, and/or artificial intelligence (AI).

One embodiment relates to a method and system for capturing and managing memorable moments in interactive media content, specifically in the context of video games. The method involves executing a video game, receiving inputs from a player to facilitate gameplay, and receiving a bookmark input to identify a frame region in a video frame. An identifier is associated with the bookmark, providing descriptive information about the content in the frame region. State data for the bookmark is saved, enabling subsequent selection and loading of the video frame along with the identifier as overlay content. The identifier can be generated from a combination of image analysis and analysis of state data associated with the video frames.

In one embodiment, eye-gaze information can be used to identify the frame region, and the bookmark can be displayed as a thumbnail image with additional metadata. Players can share these bookmarks on social media or game networks, edit identifiers, tag bookmarks for retrieval, and filter and sort bookmarks based on tags or metadata. A system for implementing this method includes a content execution engine, an input reception interface, a bookmarking processor, a user interface, and a sharing interface. An artificial intelligence (AI) module can automatically identify significant moments, analyze content within the frame, and generate descriptive identifiers using machine learning techniques. The AI model can detect emotional cues, categorize memorable moments, generate summaries, and personalize identification and description based on user preferences.

In one embodiment, a method for recording gameplay moments during gameplay of a video game is provided. The method includes executing the video game to generate a plurality of video frames. The method includes receiving inputs from a player of the video game. The inputs facilitate said gameplay of the video game by the player and causes updating of said plurality of video frames as the player makes progress in the video game. The method includes receiving an input to bookmark a frame region rendered in a video frame of said plurality of video frames. The method includes associating an identifier to the bookmark. The identifier is descriptive of content present in the frame region. The method includes saving state data for the bookmark. The state data for the bookmark enables subsequent selection of the bookmark from a user interface to load at least the video frame along with said identifier. The identifier is overlay content rendered over the video frame to identify the frame region.

In one embodiment, a system for capturing and managing memorable moments in interactive media content is provided. The system includes a content execution engine configured to execute interactive media content and generate a sequence of content frames. The system includes an input reception interface configured to receive inputs from a user interacting with the interactive media content. The inputs influence a progression of the content and updating of the content frames. The system includes a bookmarking processor configured to receive a bookmarking input corresponding to a particular content frame and associate an identifier with the content frame. The identifier provides descriptive information related to the content within the content frame, and store data associated with the content frame for later retrieval. The system includes a user interface configured to display the content frames bookmarked along with their associated identifiers and additional metadata, and to enable user interaction for selecting, editing, and organizing the bookmarked content frames. The system includes a sharing interface configured to facilitate sharing of bookmarked content frames and their associated information on external media platforms.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may be better understood by reference to the following description taken in conjunction with the accompanying drawings in which:

FIGS. 1A-1E illustrate various interactive scenarios where bookmarking operations are facilitated, and user interfaces for listing dynamic information regarding bookmarks suggested or requested, in accordance with several embodiments.

FIG. 2 illustrates a system diagram showing one exemplary layout of components usable for identifying bookmarks, intelligently analyzing image content, selecting identifier text, and integrating supplemental metadata to be displayed as part of a bookmark to be added to a bookmark user interface, in accordance with one embodiment.

FIG. 3 provides a flow diagram illustrating example operations performed for identifying and generating bookmarks during interactive gameplay, in accordance with one embodiment.

FIG. 4 illustrates components of an example device and/or platform system that can be used to perform aspects of the various embodiments of the present disclosure.

### DETAILED DESCRIPTION

The following implementations of the present disclosure provide methods, systems, and devices for enhancing the gaming experience by allowing players to capture and revisit specific moments within a game. This system empowers players to bookmark crucial or memorable instances in real-time, creating a repository of these moments for future examination and reflection. When a player encounters a moment they wish to preserve, they can trigger a bookmarking feature, which not only captures the moment but also offers the opportunity to categorize it on the spot. This categorization feature enables players to organize their bookmarked moments into distinct categories, facilitating easier navigation and review of these instances based on themes or significance.

The innovation extends further by incorporating advanced features that leverage available player data to enrich the bookmarking experience. For instance, if gaze tracking information is available (e.g., either through built-in game software or external hardware), the system can refine the bookmarked images to focus on the specific region of the screen the player was looking at the moment of bookmarking. This targeted approach ensures that the bookmarks are highly relevant and personalized, capturing not just any part of the game but the exact focus of the player's attention. Each bookmarked image can then be tagged with details about what the player was observing, providing context and insight into why the moment was deemed bookmark-worthy.

Additionally, the system can tag each bookmark with the player's precise location within the game world at the time of the bookmark. This geographical tagging adds another layer of detail to the bookmarks, allowing players to not only revisit the moment but also understand their positioning and circumstances within the game environment when the moment occurred. This feature is particularly useful for large, open-world games where location context can significantly impact the gameplay experience.

Beyond simple bookmarking, the system offers an interface for players to access their list of saved bookmarks. This interface is designed with functionality and ease of use in mind, allowing players to review their bookmarked moments, categorize them if they had not done so at the time of bookmarking, and even reload a specific moment of gameplay to re-experience it directly. The reloading feature is especially beneficial for training, strategizing, or simply reliving a particularly enjoyable or significant part of the game.

With the above overview in mind, the following provides several example figures to facilitate understanding of the example embodiments.

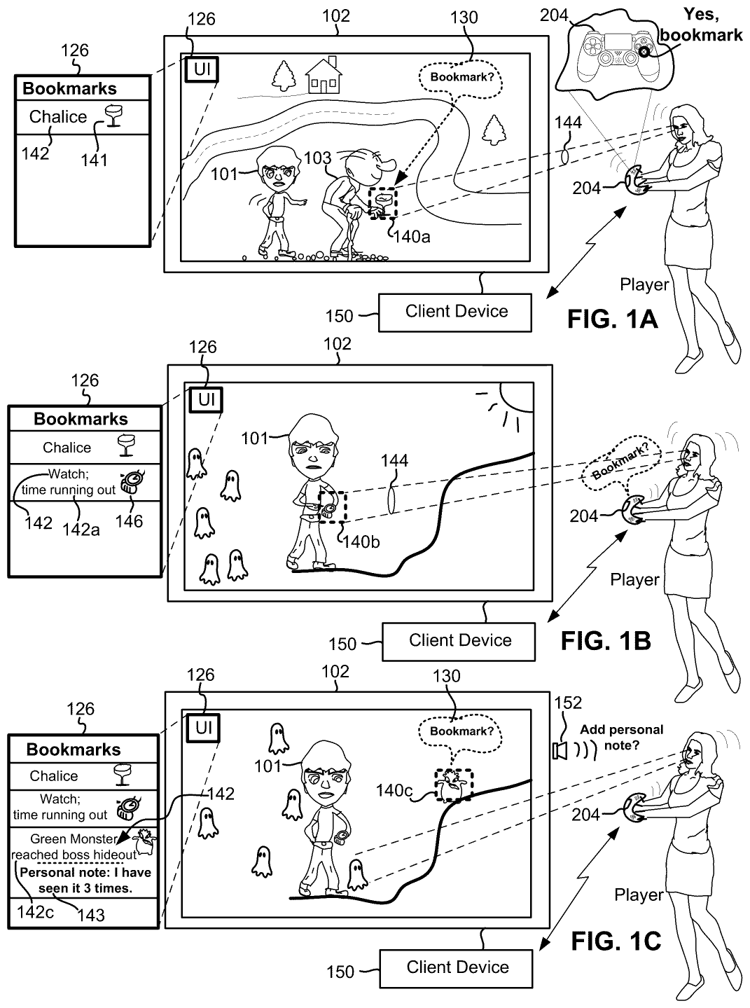

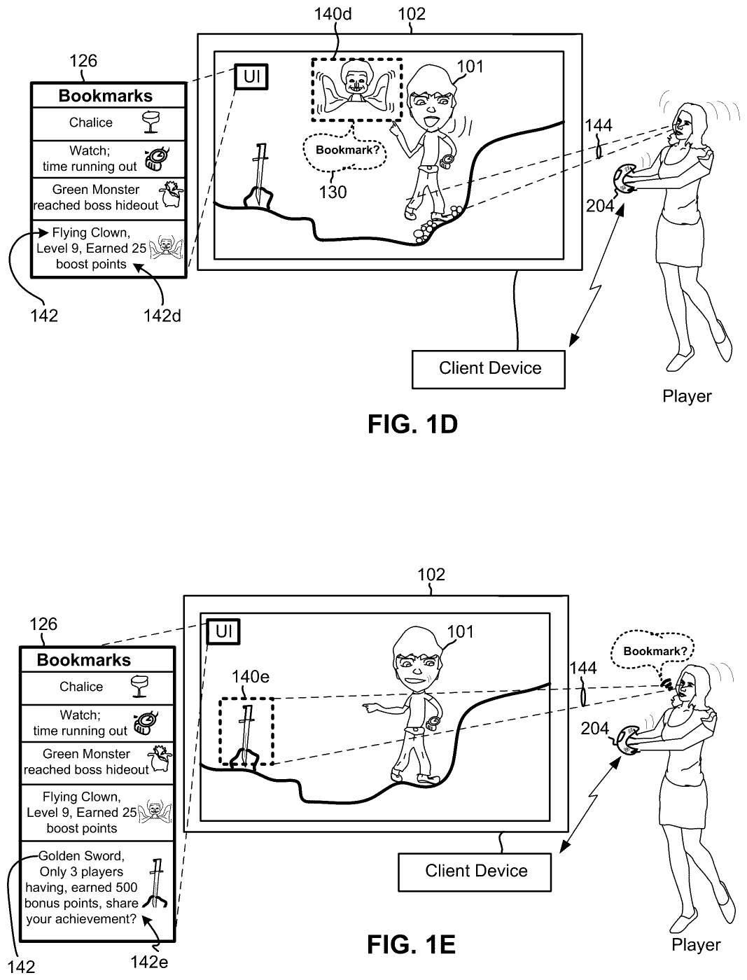

FIG. 1A illustrates a graphical design of a user interface rendered in a display 102, for a video game to display the video output, in accordance with one embodiment. In this example, a player is shown interfacing with the client device 150, which can either render video game by locally executing the game, or can connect to the Internet for cloud-based or Internet-based gaming. A controller 204 is used by the player to interface with the client device, which therefore controls the interactivity of the video game being rendered. In this example, the player character 101 is the character being controlled by the player, and the player can cause the player character to move about the game world to achieve interactive points, conquer tasks, interact with other players, advance in levels, earn trophies, and other interactive gameplay actions.

In one embodiment, a system for capturing and managing memorable moments in video games is provided. The embodiments provide for seamlessly blending player interactions, artificial intelligence (AI), and user interface design to enhance the gaming experience. By way of example, a method involves the execution of a video game, which generates a series of video frames depicting the ongoing gameplay. As the player engages with the game through various inputs, such as a controller, keyboard, or voice commands, they have the ability to bookmark specific frame regions within the video frames at any moment they deem significant or memorable.

This bookmarking mechanism allows the player to highlight and preserve key moments in their gameplay. In some embodiments, suggestions to bookmark 130 can be provided to the user without first receiving user input requesting the bookmarking. For instance, the user appears to be looking at a specific object in a frame region 140a, the bookmarking system can determine that the user's engagement in regard to frame region 140a is sufficient frame threshold of engagement that the user should be suggested to bookmark content associated with the frame region 140a.

In some embodiments, determining threshold levels of engagement can be include, without limitation, the amount of time spent in a particular area, the frequency of interactions with specific items or NPCs (non-player characters), or the intensity of reactions (like excitement or frustration) to certain events. In some examples, eye tracking can be used to see where the player is looking during gameplay, i.e., to show what captures user attention. Heatmaps may also be used, to identify areas of the game that receive the most interaction or where players spend the most time. Input frequency can also be examined, e.g., how often players interact with the game during specific frames or scenes (e.g., number of clicks, keystrokes, or controller inputs). Physiological responses, e.g., heart rate, facial expressions, and other biometrics that may indicate arousal or emotional engagement. Video frames may also be analyzed, e.g., content analysis, to identify what content is present in the frames where engagement is high. This could include characters, text, environmental details, etc. Any dynamic changes in the scene that correlate with spikes in engagement metrics may also be considered. Based on the captured data, thresholds can be set that define high engagement. For example, if eye-tracking data shows that players spend a significant amount of time looking at a particular object, or if input frequency spikes at a certain moment, these can be considered indicators of high engagement.

An example of an AI application in determining user engagement thresholds for video game content could be using a Decision Tree classifier. This classifier can help categorize gameplay moments into different levels of engagement based on features derived from gameplay data such as player inputs, time spent on tasks, or interaction patterns. Once a classifier is trained, it can be used to predict the engagement level of new gameplay sessions based on the input features.

In one embodiment, a formula for identifying an engagement threshold for digital content in a game may use a weighted sum of different engagement indicators. This formula could involve assigning weights to various measurable factors of user interaction or eye gaze, reflecting a relative importance in determining overall engagement.

Some indicators may include time Spent (T). This might be a duration of interaction or eye gaze within the session or specific areas of the game. Interaction Frequency (I) may also be gathered, e.g., number of interactions (e.g., clicks, key presses, eye gaze or screen touches) during a session. Achievements (A), may indicated a number of achievements or milestones reached in a session. Weights may then be assigned to each of these indicators based on their perceived importance. For example, ensure that the sum of all weights equals 1 (or 100 if using percentages).

For example, weight for Time Spent (W_T): 0.5; weight for Interaction Frequency (W_I): 0.3; weight for Achievements (W_A): 0.2. An example formula may multiply each indicator by its respective weight, and then sums these products to compute an overall engagement score. The formula for the engagement score (E) would be: E=(WT×T)+(WI×I)+(WA×A). A threshold value that defines what is considered “high engagement” can be set. In one embodiment, this could be based on historical data, benchmarks, or desired outcomes. For example, if scores can range from 0 to 100, a threshold my be set for 75 or greater, to define a sufficiently high engagement level to suggest a bookmark. Alternatively or in addition, machine learning (ML)/AI can be set to learn engagement levels and identify levels of engagement for particular games, particular users and/or based on the content of a game scene or game scenario(s).

In one embodiment, once the frame region 140a is identified as being of interest (e.g., having an engagement level over a predefined threshold), the image content in that frame region can be analyzed to determine what is present in that frame region. In this example, an object that appears to be a “chalice” is identified.

Identification of the object can be provided or aided using state data of the video game, which maintains information about content being rendered on the screen, and its location. In other embodiments, an artificial intelligence (AI) model can be utilized to screen capture content continuously to identify different objects being rendered on the screen. These objects can then be identified using the AI model, and can be given a name to be used as the identifier 142. In some embodiments, a combination of using the AI model and state data will provide the best identification label for the object or objects located within the frame region 140a.

If the player decides to bookmark the chalice, the bookmarking system will add an identifier 142 to a bookmarks user interface 126. Additionally, or optionally, an image 141 of the object that was captured or identified within the frame region 140a can be added to the bookmark entry. In one embodiment, saving the bookmark during gameplay can be a background event, whereby the player can simply select a button on controller 204 (e.g. the X button), and the bookmark content is added to the bookmarks user interface 126. As gameplay progresses, the user can add multiple bookmarks signify different memorable events or achievements.

The bookmarks will collect in the bookmark user interface 126 for later review. In some embodiments, as mentioned below, bookmarks can be accessed and utilized to view screen captures of the memorable events associated with the bookmark. For example, one or more frames can be displayed to show the user what occurred in relation to the bookmark. In some embodiments, the video can be played to illustrate how the player arrived at the scene in the game where the bookmark was added, and additionally, an overlay of the bookmark can be provided in the replay video. In this manner, replay of a video associated with the bookmark can provide focus to the user as to the reason why the bookmark was created and where the content associated with the bookmarking is present in the video being displayed.

FIG. 1B illustrates a continuing example of FIG. 1A, where the player character 101 is progressing through different scenes of the video game. In this example, the player appears to be looking at the wristwatch of the player character 101. The player may be thinking that time is running out to achieve the next task or an alarm may be going off associated with the wristwatch of player character 101. The gaze 144 is detected from the player looking toward the watch, which is located within frame region 140b.

As mentioned above, the frame region 140b can then be analyzed to generate an identifier for the object or content presented within the frame region 140b. In this example, the identifier 142 is for a watch, and the label of watch is associated to the bookmark added to the user interface 126. Additionally, state data being generated by the execution of the video game may be utilized and analyzed to identify any significance with the watch. The significance may be that time is running out. This information is generated at system supplemental metadata, since the information was obtained from the state data of the video game being executed.

In another embodiment, system supplemental metadata can also be obtained or generated using an artificial intelligence (AI) model that analyzes the image data and can further use an AI model to generate additional identifier content. The additional identifier content would be in the form of system supplemental metadata 142a. Broadly speaking, the system supplemental metadata 142a is additional data that is descriptive of what might be going on in the game relative to the content being added as a bookmark, e.g. the watch. Some or all of this information that is descriptive, can be obtained from one or more of the state data of the game and/or a combination of the state data of the game and an AI model performing analysis. Therefore, once the bookmark is added to the bookmarks interface 126, the user will be provided with quick identifying information related to the moments when the player was concentrating on or interested in certain content that may be memorable or significant.

FIG. 1C illustrates a further example of the utilization of bookmarks, even when the player is not actually focusing the gaze on interesting content. In this example, a green monster is shown approaching the player character 101, but the player appears to be focusing on one of the ghost characters at the feet of the player character 101. In one configuration, the bookmarking system can be continuously analyzing content being displayed on the screen during gameplay. This analysis can be done using state data being generated by the video game being executed.

This analysis can further be augmented by analyzing screen content using image recognition and AI tools that learn and model the content present in the specific video game. In this example, frame region 140c was automatically identified as a potential bookmark 130. The player may see the icon or overlay which signals potential bookmark 130 is available for adding to the players bookmarks. In one configuration, the player can provide input to accept the bookmark.

The input to accept the bookmark can be delivered in many ways, including by voice, by input, by gesture, controller input combinations, or the like. Additionally, the player can be prompted by the bookmarking system using audio, where the audio interface 152 can communicate with the player. In this example, the player is asked if the player wishes to add a personal note when adding the bookmark. In this example, the player agreed and added a personal note, which is added to the bookmark. In this configuration, the personal note added by the player is user supplemental metadata 143, which is added to the bookmark included in bookmarks 126. Additionally, system supplemental metadata 142c can also be associated with the bookmark, in addition to the identifier 142.

The identifier 142 is for a “green monster,” and system supplemental metadata 142c provides information that the player has reached the boss hideout. The user supplemental metadata 143 includes the notes by the player, indicating that the player has seen the green monster three times. As shown, various types of information can be added to the bookmark, including information that is suggested by the system or even the system suggesting the bookmark in the first place. Alternatively, the player can provide direct input to create a bookmark anytime. When the player creates a bookmark, additional metadata can also be provided by the system, as described above.

FIG. 1D illustrates a further example of a frame region 140d that would be suggested by the system as a possible bookmark 130, in accordance with one embodiment. As shown, the player is focused on the shoes of the player character 101, because the player character 101 appears to be slipping. Therefore, the gaze 144 is not focused on the frame region 140d, but it is being suggested by the system as significant or a memorable event. In this embodiment, the player acknowledges or accepts to make a bookmark and the bookmark is added to the bookmarks interface 126.

The content in the frame region 140d is analyzed as discussed above, and the content shows a flying clown for the identifier 142. System supplemental metadata 142d can also be added to the bookmark. This information can include data obtained from state data of the game, or information provided by the player. In this example, the information of “level 9,” and “earned 25 bonus points” is provided by system supplemental metadata discussed above. Additionally or optionally, an image contained in the frame region 140d, e.g. the flying clown, can be added to the bookmark.

FIG. 1E illustrates another example where the player is focusing gaze at an object being displayed. The object is a golden sword, and the player character 101 appears to be pointing at it with great joy. In one example, a golden sword might be an object as achieved or one by the player after obtaining a certain level of success, and therefore would be memorable or an enjoyable event that should be or could be bookmarked. The player accepts the bookmark and the bookmark is added to the bookmarks user interface 126.

As shown, an identifier 142 is added as a descriptive word for the object “golden sword.” Additionally, other system supplemental metadata is provided to the bookmark. In this example, the added metadata is descriptive content that says “only three players have earned 500 bonus points, share your achievement?” This information can be gathered from gameplay history, which can be accessed from a server or game service provider. This information can be gathered and further formatted for the addition to the bookmarks. For example, the content identified from gameplay history of the player and other players can be extensive and/or in the form of comprehensive metadata. This comprehensive metadata can be descriptively adjusted using AI, so as to summarize the information that should be displayed along with the bookmark.

In one embodiment, once a frame region is bookmarked, an identifier is associated with it. This identifier is not arbitrary; it is carefully generated based on the content present within the frame region, utilizing a combination of image analysis and state data analysis. The image analysis might involve recognizing characters, objects, or actions within the frame, while the state data analysis provides context by considering factors such as the game level, score, or character status at the time of bookmarking. The result is a descriptive identifier that encapsulates the essence of the bookmarked moment.

As can be appreciated, the bookmarking process is assisted by automation that includes artificial intelligence, and analysis of gameplay content. As the player progresses through the game, additional bookmarks can be collected. In some embodiments, after the gameplay session is done, the player can review the various bookmarks and decided to view content associated with the bookmark or share the bookmark with other players. In some embodiments, multiple bookmarks can be assembled to create a highlight reel of the significant events captured by the bookmarking functionality.

One method extends beyond simple bookmarking; and ensures that the state data for the bookmark is saved, enabling the reconstruction of the game state at the moment of bookmarking. This includes saving information such as character attributes, inventory items, and the player's position in the game world. Additionally, access to executable code is stored to facilitate the replay of the video frames surrounding the bookmarked frame, allowing players to revisit their memorable moments in a more immersive manner.

In one embodiment, the visualization of these bookmarks is handled through the creation and display of thumbnail images in a user interface. Each thumbnail includes the video frame along with overlay content such as the identifier and additional metadata describing the gameplay moment. This metadata can be as simple as a timestamp, descriptive content, and/or the player's score or game level at the time of bookmarking. Players are not just passive viewers of these thumbnails; they can actively interact with them, selecting, editing, and organizing their collection of memorable moments. The system also supports sharing these bookmarks on social media platforms or game networks, adding a social dimension to the gaming experience.

In one embodiment, players can create a personalized reel that captures their most significant gameplay moments, with the option to automatically generate the reel based on selected criteria such as high scores or emotionally impactful scenes. Furthermore, players can customize the identifiers for each bookmark, providing their own personal descriptions of the moments, and organize their bookmarks using tags and filtering mechanisms. This level of customization and organization enhances the player's ability to navigate and access their memorable moments with ease.

Further, in one embodiment, a system that implements this method can be equipped with advanced features that leverage AI and machine learning to enrich the user experience. An AI module within the bookmarking processor can automatically identify significant moments in the gameplay, ensuring that key moments are captured without constant input from the player. The AI model also analyzes the content within the frame region using a variety of machine learning techniques, including computer vision for image recognition, natural language processing for text analysis, and audio analysis for sound recognition. This comprehensive analysis contributes to the generation of accurate and descriptive identifiers.

Moreover, the AI model is capable of detecting emotional cues in the gameplay, such as facial expressions of characters or the intensity of the music. Moments of heightened emotional impact can be automatically bookmarked, capturing the most impactful scenes. The AI model also personalizes the identification and description of memorable moments based on the player's preferences and viewing history, ensuring that the bookmarks are tailored to the individual's interests and play style. Additionally, the AI model utilizes deep learning algorithms to continuously improve its accuracy in identifying significant moments and generating descriptive identifiers, with user feedback on previously bookmarked content frames being used to refine the model's performance over time.

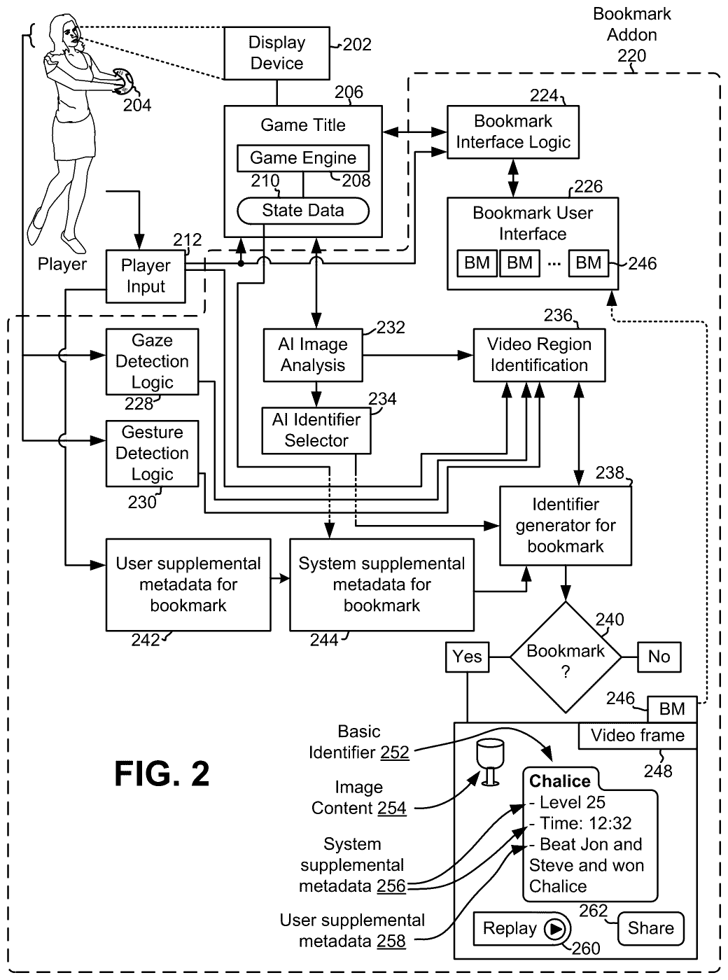

FIG. 2 illustrates a system diagram of a bookmark add-on program 220, which is interfaced with the game system 206 that is executing a game title using a game engine 208, in accordance with one embodiment. As shown, a player may be interfacing with the game system 206 using a controller 204, while viewing the display device 202. The game system 206 may be integrated with the bookmark add-on program 220 in a way that active interfacing is done between the executing game title and the logic associated with the bookmark add-on 220.

By way of example, the game title can be produced by any studio, and the bookmark add-on 220 can be interfaced with the game title when executed by a game engine 208. In one embodiment, the game system 206 is coupled to display device 202, and is configured to receive player input 212. The player input 212 can be from the controller 204, voice input, gesture input, or a combination thereof. The bookmark add-on program 220 includes a number of system elements that enable the interfacing with the executing game title in a manner that enables the generation of bookmarks as described above.

A bookmark interface logic 224 is shown in communication with the execution of the game title. In one embodiment, application programming interfaces (APIs) can be utilized to pass communication between the game system 206 logic and the logic executed by the bookmark add-on 220. Generally speaking, if the bookmark add-on 220 is integrated with the game system 206, the bookmark add-on program 220 would be executed by the game system 206, e.g. using associated hardware. In other embodiments, the bookmark add-on 220 can be executed on a server along with the execution of the game title.

It should be understood that all the bookmark add-on 220 is shown separate from the game system 206, game system 206 can include the logic for processing the bookmarking when integrated as part of the executing software managed by the game engine 208 of game title. In one embodiment, gaze detection logic 228 and gestured detection logic 230 can be implemented to track interactivity by the player during gameplay. The interactivity can include the player's movements, eye gaze, inputs, and the like utilized to advance and move throughout different scenes of the video game. The player input 212 is communicated to the game system 206 to drive interactivity. During interactivity, an artificial intelligence (AI) image analysis 232 is performed to determine content present in different video regions of frames shown during the interactive gameplay.

At certain points during gameplay, certain content may be identified by the AI image analysis 232 and/or analysis of state data 210. The combination of image analysis and state data analysis assist in identifying video regions in block 236. As mentioned above and by way of example, the video region can be frame region 140a, where a chalice is identified to be present in the frame region 140a. Additionally, an AI identifier selector 234 can be run to separately identify the wording for the identifier. For example, the wording for the identifier of the bookmark can include the word “chalice,” which is present in the frame region 140a.

The output of AI identifier selector 234 is then passed to identifier generator for bookmark 238. identifier generator for bookmark 238 determines the appropriate identifier to generate for the bookmark based on the output received from video region identification 236 and AI identifier selector 234. As mentioned above, identification of image content present in a frame region and determining what the content is can be performed utilizing analysis of state data and/or state data and AI image analysis. Once the images recognize, optional descriptions of an identifier for the content is generated by the AI identifier selector 234.

The identifier generator for bookmark 238 will select the most appropriate description for the content, with the aid of information from the state data and other analysis described above. By way of example, the AI identifier selector 234 may identify various descriptive words, such as cup, bowl, trophy, chalice, etc. Using state data analysis, the context of the game scene will indicate that a “chalice” is being held by the nonplayer character 103 shown in FIG. 1A. Therefore, the identifier 142 is selected to be “chalice.”

In one embodiment, in addition to providing the identifier 142, it is possible for the system to generate additional identifying information, statistics, or interesting notes of gaming or progress. One way to provide additional notes or information to an identifier of the bookmark is to receive user supplemental metadata for the bookmark 242. By way of example, the player can type in additional description for the bookmark. The player can also provide verbal description for the bookmark. Generative AI can also be used to edit the verbal description to be more concise or context specific to the game and/or events occurring related to the bookmark.

Additionally, system supplemental metadata for the bookmark 244 can also be generated. This information can be generated by accessing state data 210. For instance, the state data 210 can track progress in the game and/or access other state data from other players to generate supplemental information that can be used as an identifier for the current bookmark.

In one embodiment, the bookmark can be triggered to generate based on user input. If the bookmark generation is triggered by the user, then operation 240 will revert to yes. If the user rejects a suggested bookmark, the decision in operation 240 is no, and no bookmark will be generated. In some embodiments, bookmarks are suggested to the user, even if the user is not directly gazing at the content. If the user wishes to add the bookmark, then the answer would be yes, which produces bookmark 246. As shown, bookmark 246 would then be added to a bookmark user interface 226. In some embodiments, the bookmark 246 is a thumbnail of content, which when expanded can be accessed for more details. For example, when bookmark 246 is provided in the user interface 226, multiple thumbnails of bookmarks can be illustrated and made selectable.

Bookmark 246 includes a basic identifier 252, which is the word chalice. Image content 254 is also provided in the bookmark 246, which is an image or graphic of the content that was found to be of interest or memorable in the frame region 140. System supplemental metadata 256 can be provided as part of the details in the bookmark. The system supplemental metadata can include information related to the game level, the time in the game, and other information. User supplemental metadata 258 can also be provided. This information was provided by the player to read (beat John and Steve and one chalice). In one embodiment, the bookmark can also include an interface that would allow the user to view the video frame 248 where the bookmark content originated.

In some embodiments, the user is able to hit a replay button 260, which would allow viewing of the video content that occurred up to the point of the bookmark and one or more frames after for context. In some embodiments, when the player is doing a replay 260, metadata and state data is utilized by a game engine to enable full read creation of the game and enable user interactivity if desired (instead of simple static viewing). In other embodiments, the replay mode 260 would allow viewing of a video replay of the bookmark content, and providing an overlay image that signals or identifies where the bookmark content originated from. For example, in the replay mode, a bookmark floating identifier can be placed near or proximate to the chalice, as shown in FIG. 1A.

Bookmarks can also be shared 262, which would allow another player to view the bookmark, or view a video of the content that generated based on the bookmark. Sharing of bookmarks can occur utilizing a sharing button on the controller, or other user interface.

The example described with respect to FIG. 2 was to show the generation of a bookmark 246. However, additional bookmarks would and can be generated during continues gameplay. The result being multiple bookmarks shown in the bookmark user interface 226. This would allow the player to review all bookmarks collected for gameplay session, or review all bookmarks for the entire history of gameplay for the game title. In some embodiments, the various bookmarks can be organized and classified according to activities occurring in the game.

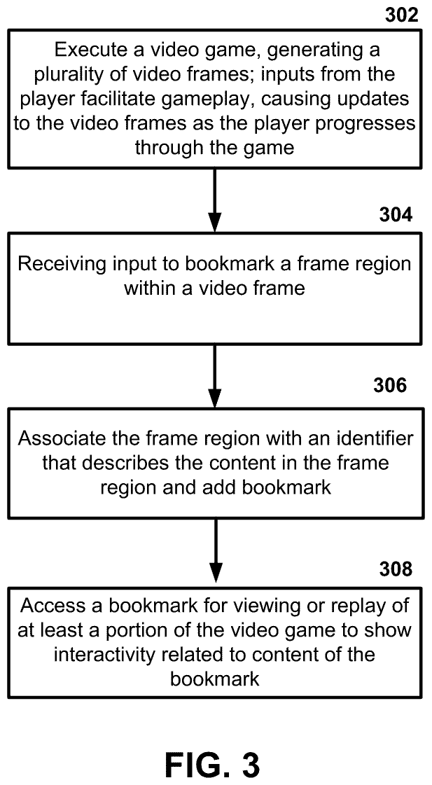

FIG. 3 illustrates a method flowchart describing exemplary functionality of the system for bookmarking, in accordance with one embodiment of the present invention. In operation 302, a video game is executed and a plurality of video frames are generated. The video frames are generated responsive to inputs from player to facility gameplay. The gameplay at user inputs cause updates the video frames as the player progresses through the game.

In operation 304, input is received to bookmark a frame region within a video frame. In one embodiment, the input can be direct input from the player wishing to bookmark some content displayed in a frame of the video game. In another embodiment, the input is received after a bookmark is suggested to the player based on interest detected by the player for a specific content item displayed on the screen. In other embodiments, suggestions to bookmark are provided to the player based on interesting interactive content occurring in the video game, which may not have been noticed by the player. Interactive context analysis of game state data is processed to identify various content that may be of interest for bookmarking, including video analysis using AI to select content for bookmarking and/or suggesting bookmarks to a player.

In operation 306, a frame region is associated with an identifier that describes content in the frame region for a bookmark to be added. For example, the frame region can identify some object being displayed during the interactive gameplay. By way of example, the object may be a chalice, as shown in FIG. 1A. The frame region can be identified responsive to eye gaze information received from the player, and/or analysis of image content using AI for interesting content occurring in the game and/or contextual analysis. In one embodiment, if the bookmark is accepted by the player, the bookmark is generated with identifier information and additional data that would provide a thumbnail of what the image was in the game that produced or related to the bookmark. As mentioned above, other supplemental metadata can also be generated for the bookmark, to provide more interest in details regarding the context and reasons for generating the bookmark.

In operation 308, the bookmark may be accessed for viewing or accessed to replay of at least a portion of the video game to show interactivity related to content of the bookmark. In this manner, it is possible to identify why the bookmark was selected if another player or spectator is later viewing the bookmark and it's interactive content.

In some embodiments, a crop to focus function may be used if gaze data is available. The bookmark image can be cropped to the gaze region (or the region outside the gaze can be dimmed). In some embodiments, focus-Aware Tags can be provided. The gaze can be used to add extra tags/info to the bookmark based on what is in the image. For example, if the player is looking at a chalice that a player was holding, the tag “chalice” could be added which can later become searchable or filterable in the bookmark review system.

In some embodiments, features can be implemented with functions that do a raycast in the game world to see what the gaze was directed toward. The raycast can also sample a region to capture other potential elements that the player may have been looking at (to compensate for eye tracking inaccuracy or eye movements). The name of the asset that the raycast hits can be used to create the tag. Alternatively, data from the draw calls can be used to extract the asset name.

In some embodiments, gaze gestures and voice can be processed. The content bookmarked does not need to be limited to one item but it can also be several elements and regions on the screen. One way to achieve this would be a voice command to say: “mark this”, “and this”, “and this”, where the user looks at different areas to mark.

In other embodiments, pointer selection can be used. The user can also use their hands via the controller to point and select regions of the screen or virtual environment. Again, this can also be initiated and expanded on via voice just like the gaze gestures.

In some embodiments, map visualization can be processed. The bookmarks can be saved with the location in the game map where they were created so later on, in the bookmark display system, an option of showing the bookmarks overlaid on a map is provided.

In still other embodiments, categorizing of bookmarks is provided. In one non-limiting example, right after the user requests a moment to be bookmarked, they can also assign it to a category. This can be done in several ways such as (a) using voice “put it in the funny moments category” (b) with a head gesture (tilting head up/down/left/right would indicate four different categories) or (c) with simple button presses.

Alternatively, untagged bookmarks can be queued up and shown at a later time for the user to label and group together as needed.

Biometric Enhancement and Suggestions can also be provided. The system can record facial expressions and biometrics including pupil dilation of the user. This information can be used to tag the bookmarks with an “excitement level”, and even auto-suggest what category bookmark should go into (“funny”, “scary”, “sad” categories) or it learns that things that are funny probably belong to your “glitch moments” category. The system can also learn bookmarking patterns and suggest “would you like a to bookmark this moment?”. Similarly, if the system has knowledge of other user's bookmarking behavior, it can make the suggestions of what to bookmark based on other players. For example, if you bookmarked moment A and B, the system will look at the data and see for people who bookmarked moment A and B, what other things did they also bookmark and suggest those to you.

In one embodiment, the system might be able to automatically bookmark using for instance, pupil dilation as an indicator of highly exciting moments. Then later (e.g. at the end of the session), the system can ask the player to confirm if they want to bookmark those episodes. In one example, if the player is facing a big boss or a highly action moment, the player might not have time to bookmark things. They system could use gaze tracking plus pupil dilation (or other physiological info) to automatically bookmark moments.

Reloading Bookmarks is also provided, in one embodiment. When reviewing the bookmark list, a user can select a bookmark to see the image it corresponds to. But also, the user may choose to reload the game state corresponding to the bookmark, essentially returning to the game the moment the bookmark was requested. In this configuration, bookmarks function as pointers to moments of gameplay that can be reloaded and revisited. This can be done by saving console game state along with the bookmark, and loading it back up.

Supplementary Video may also be provided. For example, the system can save the video of moments before and after the bookmark request (along with the gaze movement) to make sure the moment desired is correctly captured. The user can later choose to review and adjust the associated bookmark photo by reviewing the video.

Bookmark Aggregation/Recommendation can also be provided. This function aggregates the bookmarks information from other players. The system can provide additional info (or suggest bookmarks) like “this bookmark is very popular among your friends/players you follow/other players with similar interests/other players with similar play style”. Moreover, the aggregated information of bookmarks can be helpful for game studios/creators about the episodes that players like the most.

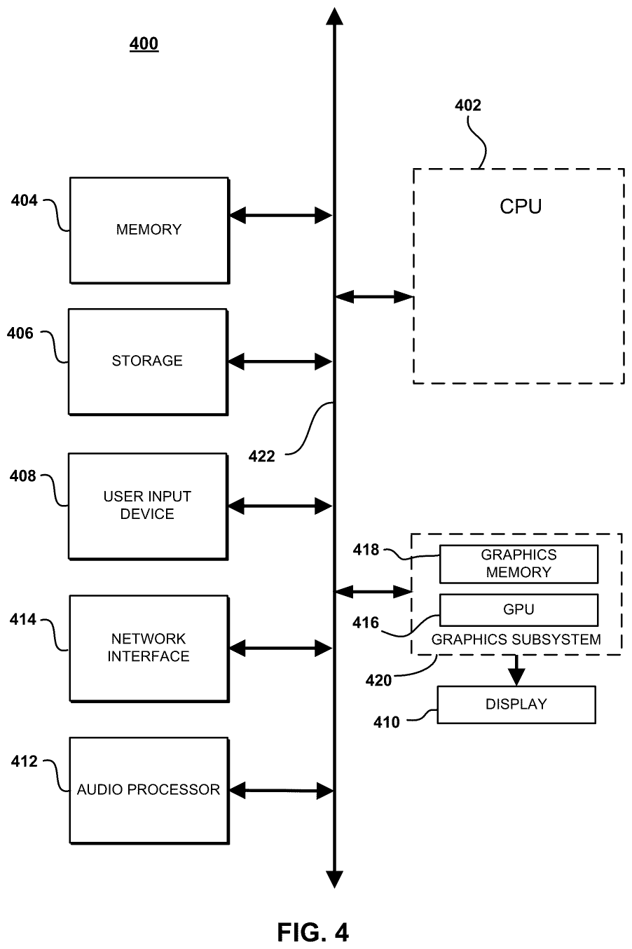

FIG. 4 illustrates components of an example device 400 that can be used to perform aspects of the various embodiments of the present disclosure. This block diagram illustrates a device 400 that can incorporate or can be a personal computer, video game console, personal digital assistant, a server or other digital device, suitable for practicing an embodiment of the disclosure. Device 400 includes a central processing unit (CPU) 402 for running software applications and optionally an operating system. CPU 402 may be comprised of one or more homogeneous or heterogeneous processing cores. For example, CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 400 may be localized to a player playing a game segment (e.g., game console), or remote from the player (e.g., back-end server processor), or one of many servers using virtualization in a game cloud system for remote streaming of gameplay to clients.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 412 is adapted to generate analog or digital audio output from instructions and/or data provided by the CPU 402, memory 404, and/or storage 406. The components of device 400, including CPU 402, memory 404, data storage 406, user input devices 408, network interface 410, and audio processor 412 are connected via one or more data buses 422.

A graphics subsystem 420 is further connected with data bus 422 and the components of the device 400. The graphics subsystem 420 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 408, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In one embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs.

The graphics subsystem 414 periodically outputs pixel data for an image from graphics memory 418 to be displayed on display device 410. Display device 410 can be any device capable of displaying visual information in response to a signal from the device 400, including CRT, LCD, plasma, and OLED displays. Device 400 can provide the display device 410 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, gameplay replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as HTML, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen input corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from them, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation may be produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method for recording gameplay moments during gameplay of a video game, comprising:
executing the video game to generate a plurality of video frames;
receiving inputs from a player of the video game, the inputs facilitate said gameplay of the video game by the player and causes updating of said plurality of video frames as the player makes progress in the video game;
receiving an input to bookmark a frame region rendered in a video frame of said plurality of video frames;
associating an identifier to the bookmark, the identifier is descriptive of content present in the frame region; and
saving state data for the bookmark, the state data for the bookmark enables subsequent selection of the bookmark from a user interface to load at least the video frame along with said identifier.

2. The method of claim 1, wherein the identifier is descriptive text data generated from a combination of image analysis of the content present in the frame region and analysis of state data associated with said plurality of video frames that include the video frame.

3. The method of claim 2, wherein eye-gaze information captured of the player is used in part to identify frame region.

4. The method of claim 3, wherein the bookmark is a thumbnail image that includes the video frame along with the overlay content, and wherein the thumbnail image is displayed in the user interface with other metadata that is descriptive of a gameplay moment of the player, wherein the identifier is overlay content rendered over the video frame to identify the frame region.

5. The method of claim 4, wherein the thumbnail image is one of a plurality of thumbnail images for a respective plurality of gameplay moments of the player, the plurality of thumbnail images are individually selectable, wherein selection of one of the thumbnail images provides additional descriptive information related to the bookmark and enablement to trigger a replay of one or more video frames showing interactivity that occurred before and or after the video frame having the bookmark associated therewith.

6. The method of claim 5, wherein the additional descriptive information includes at least one of a timestamp, a score achieved by the player at a time of the bookmark, or an indication of a level or stage in the video game.

7. The method of claim 5, further comprising enabling the player to share the thumbnail image along with its associated descriptive information on a social media platform or a game network.

8. The method of claim 1, wherein the input to bookmark a frame region is received via a voice command issued by the player.

9. The method of claim 1, further comprising generating a highlight reel comprising a sequence of bookmarked video frames, each associated with its respective identifier, and enabling playback of the highlight reel.

10. The method of claim 9, wherein the highlight reel is automatically generated based on criteria selected by the player, including bookmarks associated with high scores or critical gameplay moments.

11. The method of claim 1, further comprising enabling the player to edit the identifier associated with a bookmark to provide a custom description of the content present in the frame region.

12. The method of claim 1, wherein the state data for the bookmark includes game state information such as character attributes of the player, inventory, and position in a game world of the video game at a time of the bookmark, and access to executable code for enabling replay of the plurality of video frames that include the video frame having the bookmark.

13. The method of claim 1, further comprising enabling the player to tag the bookmark with one or more keywords for retrieval and organization of bookmarks.

14. The method of claim 13, further comprising, enabling input to filter and sort bookmarks based on the tags, the identifier, or other metadata associated with the bookmarks.

15. A system for capturing and managing memorable moments in interactive media content, comprising:
a content execution engine configured to execute interactive media content and generate a sequence of content frames;
an input reception interface configured to receive inputs from a user interacting with the interactive media content, wherein said inputs influence a progression of the content and updating of the content frames;
a bookmarking processor configured to receive a bookmarking input corresponding to a particular content frame, associate an identifier with the content frame, wherein the identifier provides descriptive information related to the content within the content frame, and store data associated with the content frame for later retrieval;
a user interface configured to display the content frames bookmarked along with their associated identifiers and additional metadata, and to enable user interaction for selecting, editing, and organizing the bookmarked content frames; and
a sharing interface configured to facilitate sharing of bookmarked content frames and their associated information on external media platforms.

16. The system of claim 15, wherein the bookmarking processor comprises an artificial intelligence (AI) module configured to automatically identify significant moments in the interactive media content and generate a bookmarking input for those moments.

17. The system of claim 15, wherein an artificial intelligence (AI) model is further configured to analyze the content within the content frame using machine learning techniques to generate the identifier with said descriptive information.

18. The system of claim 17, wherein eye gaze of the user is analyzed using said AI model to identify a type of said content within the content frame.

19. The system of claim 17, wherein the machine learning techniques include one or more of natural language processing for analyzing text, computer vision for analyzing images, and audio analysis for analyzing sound within the content frame.

20. The system of claim 17, wherein the AI model is trained to recognize patterns associated with memorable moments based on user feedback on previously bookmarked content frames.

21. The system of claim 17, wherein the AI model utilizes deep learning algorithms to continuously improve its accuracy in identifying significant moments and generating descriptive identifiers over time.

22. The system of claim 17, wherein the AI model is further configured to suggest edits to the descriptive information associated with bookmarked content frames based on contextual analysis of the interactive media content.

23. The system of claim 17, wherein the AI model is configured to detect detecting emotional cues in the interactive media content to identify moments of heightened emotional impact for bookmarking.

24. The system of claim 17, wherein the AI model is further configured to categorize bookmarked content frames based on types of memorable moments, such as action sequences, pivotal plot points, or humorous scenes.

25. The system of claim 17, wherein the AI model is configured to generate summaries of the bookmarked content frames, providing an overview of the memorable moments captured.

26. The system of claim 17, wherein the AI model is further configured to personalize the identification and description of memorable moments based on user preferences and viewing history.
